(19) United States
(12) Patent Application Publication
(10) Pub. No.: US 2010/0025209 A1
(43) Pub. Date: Feb. 4, 2010

(54) METHOD FOR DETECTING A SWITCH POSITION OF AN ISOLATING SWITCH, OR OF A GROUNDING SWITCH

(76) Inventors: Stephan Rister, Nurnberg (DE); Armin Wolf, Erlangen (DE)

Correspondence Address: HARNESS, DICKEY & PIERCE, P.L.C., P.O.BOX 8910, RESTON, VA, 20195, US

(21) Appl. No.: 12/449,028

(22) PCT Filed: Dec. 14, 2007
(86) PCT No.: PCT/EP2007/063954

§ 371 Date: Jul. 21, 2009

(30) Foreign Application Priority Data
Jan. 22, 2007 (DE) 10 2007 003 169.8

(51) Int. Cl. H01H 9/16

(52) U.S. Cl. 200/308

(57) ABSTRACT

A method is disclosed for detecting the switch position of an isolating switch, or of a grounding switch, wherein a displaceable switching meter is applied to the contact part in the gap of a contact part in the closed switch position, and wherein the displaceable switch meter can be spaced from the contact part in the open switch position. In at least one embodiment, an optical signal is influenced by the switch meter for differentiating the two switch position with a closed switch position. If the optical signal is influenced, it is indicated that the isolating switch, or the grounding switch, is in the closed switch position. Otherwise it is indicated that the isolating switch, or the grounding switch, is in the open switch position.

### PRIORITY STATEMENT

This application is the national phase under 35 U.S.C. §371 of PCT International Application No. PCT/EP2007/063954 which has an International filing date of Dec. 14, 2007, which designated the United States of America, and which claims priority on German patent application number DE 10 2007 003 169.8 filed Jan. 22, 2007, the entire contents of each of which are hereby incorporated herein by reference.

### FIELD

At least one embodiment of the invention generally relates to a method for identification of the switch position of a switch disconnector or of a grounding switch; for example, one in which, in the closed switch position, a moving switching blade rests on the contact part in the gap of a contact part, and/or in which, in the open switch position, the moving switching blade is at a distance from the contact part.

### BACKGROUND

By way of example, switch disconnectors are used as overhead line switch disconnectors or as switch disconnectors in switchgear assemblies for the railroad power supply network, or national grids.

A switch disconnector is an apparatus which is known per se and by which the power supply in a section of an overhead line or a section of a power supply network is interrupted. A grounding switch produces a safe connection between an overhead line or switchgear assembly and ground potential. Since such an interruption of the power supply and such a connection to ground potential is provided in order to carry out work safely on the overhead line or in switchgear assemblies, it is absolutely essential for safety reasons that the switch position is monitored, while people are located in the danger area.

Conventional position switches cannot be used on the switch disconnector, since they are operated electrically. Their supply lines would reduce the creepage distance and the air gap between the insulators associated with the switch. It would therefore not be possible to comply with the standard requirements. This could even endanger personnel.

It has therefore already been proposed that the switch position of the switch disconnector or grounding switch be determined indirectly via the drive motor of the switch disconnector or grounding switch, and there via the position of the drive shaft. However, there are influences on the position of the switching blade relative to the contact part which do not affect the position of the drive shaft. The switch position therefore cannot be determined with a level of reliability appropriate for the requirements.

### SUMMARY

At least one embodiment of the invention specifies a method for identification of the switch position of a switch disconnector or of a grounding switch, by which the position of the switching blade relative to the contact part is identified reliably without reducing the creepage distance or the air gap between the insulators.

### DETAILED DESCRIPTION OF THE EXAMPLE EMBODIMENTS

According to an example embodiment of the invention, in order to distinguish between the two switch positions, an optical signal is influenced by the switching blade in the closed switch position, and, when the optical signal is influenced, this indicates that the switch disconnector or the grounding switch is in the closed switch position, and otherwise, this indicates that the switch disconnector or the grounding switch is in the open switch position.

This results in the advantage that, on the one hand, the position of the switching blade relative to the contact part is detected directly and, on the other hand, no specific current-carrying line is required directly on the switching blade or on the contact part in order to carry out the method of an embodiment.

Reliable identification of the switch position is therefore possible, which complies with the safety requirements. This is a result of the fact that an optical signal is used.

By way of example, the optical signal is visible light, infrared light or light emitted by a laser.

By way of example, the optical signal is passed through optical waveguides from a transmitter to the switch disconnector or grounding switch, and from there to a detector which identifies a signal which has not been influenced. By way of example, the transmitter for the optical signal for example for light, is a conventional light source. By example, the detector for the optical signal, for example for light, is a conventional light sensor. This advantageously makes it possible to identify the switch position using an optical device(s).

By way of example, if the detector identifies an optical signal, this signal is passed via optical waveguides to a base appliance in which the optical signal is converted to an electrical output signal.

By way of example, the indication changes only when the optical signal is influenced or is no longer influenced for a predetermined time period. This advantageously prevents brief fluctuations in the detected optical signal from being able to lead to quickly successive changes in the indication.

By way of example, the optical signal is not deflected in the open switch position, and is reflected on the switching blade, and is therefore influenced, in the closed switch position. The reflection on the switching blade clearly identifies whether the switching blade is or is not inserted into the contact part. The switch position is reliably identified.

By way of example, the optical signal is reflected on a specific, coded reflective surface of the switching blade. The optical signal is therefore defined more precisely.

By way of example, in the closed state, the switching blade presses on a pressure contact, by which a mechanical signal is initiated, which is converted to an optical signal.

The method for identification of the switch position of a switch disconnector or of a grounding switch according to an embodiment of the invention in particular achieves the advantage that the position of the switch disconnector or of the grounding switch is identified reliably, thus ensuring whether or not an overhead line section or a switchgear assembly has been disconnected or grounded. This precludes any danger to people working on the disconnected or grounded overhead line section. This also applies to the disconnected or grounded switchgear assembly.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for identification of a switch position of at least one of a switch disconnector and a grounding switch, in which, in a closed switch position, a moving switching blade rests on a contact part in a gap of a contact part, and in which, in an open switch position, the moving switching blade is at a distance from the contact part, the method comprising:
producing, upon the switching blade pressing on a pressure contact of at least one of a switch disconnector and a grounding switch, a mechanical signal;
converting the mechanical signal into an optical signal;
indicating, upon the optical signal being influenced, that at least one of the switch disconnector and the grounding switch is in the closed switch position; and
indicating, when the optical signal is not influenced, that at least one of the switch disconnector and the grounding switch is in the open switch position.

2. The method as claimed in claim 1, wherein the optical signal is visible light, infrared light, or light emitted by a laser.

3. The method as claimed in claim 1, wherein the optical signal is passed through optical waveguides from a transmitter to at least one of the switch disconnector and grounding switch, and from there to a detector which identifies a signal which has not been influenced.

4. The method as claimed in claim 1, wherein the indication changes only when the optical signal is influenced or is no longer influenced for a time period.

5.-7. (canceled)

8. The method as claimed in claim 1, wherein the optical signal includes at least one of visible light, infrared light, and light emitted by a laser.

9. The method as claimed in claim 2, wherein the optical signal is passed through optical waveguides from a transmitter to at least one of the switch disconnector and grounding switch, and from there to a detector which identifies a signal which has not been influenced.

10. The method as claimed in claim 8, wherein the optical signal is passed through optical waveguides from a transmitter to at least one of the switch disconnector and grounding switch, and from there to a detector which identifies a signal which has not been influenced.

11. The method as claimed in claim 2, wherein the indication changes only when the optical signal is influenced or is no longer influenced for a time period.

12. The method as claimed in claim 3, wherein the indication changes only when the optical signal is influenced or is no longer influenced for a time period.

13. The method as claimed in claim 8, wherein the indication changes only when the optical signal is influenced or is no longer influenced for a time period.

14. The method as claimed in claim 9, wherein the indication changes only when the optical signal is influenced or is no longer influenced for a time period.

15. The method as claimed in claim 10, wherein the indication changes only when the optical signal is influenced or is no longer influenced for a time period.
